(19) United States
(12) Patent Application Publication
(10) Pub. No.: US 2024/0354180 A1
(43) Pub. Date: Oct. 24, 2024

(54) API EXECUTION CONTROL SYSTEM, API EXECUTION CONTROL METHOD, AND API EXECUTION CONTROL PROGRAM

(71) Applicant: Hitachi, Ltd., Tokyo (JP)

(72) Inventor: Kazumasa NOMURA, Tokyo (JP)

(21) Appl. No.: 18/588,123

(22) Filed: Feb. 27, 2024

(30) Foreign Application Priority Data
Apr. 18, 2023 (JP) 2023-068071

(51) Int. Cl. G06F 9/54

(52) U.S. Cl. CPC G06F 9/543

(57) ABSTRACT

An API execution control system including: an API reception unit configured to receive a plurality of successive API execution requests from a user; a table update unit configured to detect patterns of the plurality of received successive API execution requests and register the detected patterns of the plurality of successive API execution requests in an API group management table; an API execution prediction unit configured to determine whether the API execution request received by the API reception unit matches the pattern registered in the API group management table; and an API execution control unit configured to, when it is determined that the API execution request received by the API execution prediction unit matches the pattern registered in the API group management table, raise an execution priority of an API whose next execution request is to be received.

### CROSS-REFERENCE TO RELATED APPLICATION

The present application claims priority from Japanese application JP2023-068071, filed on Apr. 18, 2023, the content of which is hereby incorporated by reference into this application.

### BACKGROUND OF THE INVENTION

### 1. Field of the Invention

The present invention relates to an API execution control system, an API execution control method, and an API execution control program.

### 2. Description of the Related Art

Recently, multitenancy has progressed, and the storage API execution frequency from the user has become higher than before. In addition, since there are limited storage resources, the number of APIs that can be simultaneously executed is also limited. Among them, there is an increasing need to preferentially process APIs with high importance. Furthermore, by mediating a storage operation from an end user by a cloud system or the like, the cloud system has increasingly issued several tens or more storage APIs (storage API groups) to a storage for a certain end-user operation, and an execution frequency of the storage API has further increased.

For example, JP 2017-16408 A discloses a system including: an API message reception unit that discriminates a requester or/and a request-source system of an API request and authenticates the API request; a priority registration table by request-source that holds a combination of a unique identifier indicating the requester or/and the request-source system of each API request, and a priority; a priority determination unit that refers to the priority registration table by request-source based on the requester or/and the request-source system of the API request and determines the priority of the API request; and a control target determination unit that determines whether to preferentially process the API request according to the determined priority.

### SUMMARY OF THE INVENTION

The end-user operation and the number of storage APIs executed are in a one-to-many relationship. A method of queuing individual storage APIs according to priority has been a conventional technique, but a method of collectively managing a plurality of storage API groups executed by extension of an end-user operation and performing QoS control has not been studied. That is, although there is QoS control based on individual storage API, a system capable of providing QoS based on an end-user operation has not been studied.

An object of the present invention is achieved by an API execution control system including: an API reception unit configured to receive a plurality of successive API execution requests from a user; a table update unit configured to detect patterns of the plurality of received successive API execution request and register the detected patterns of the plurality of successive API execution requests in an API group management table; an API execution prediction unit configured to determine whether the API execution request received by the API reception unit matches the pattern registered in the API group management table; and an API execution control unit configured to, when it is determined that the API execution request received by the API execution prediction unit matches the pattern registered in the API group management table, raise an execution priority of an API whose next execution request is to be received.

According to the present invention, the QOS of the API execution system can be controlled. Problems, configurations, and effects other than those described above will be clarified by the following description of embodiments.

### BRIEF DESCRIPTION OF THE DRAWINGS

FIG. 1 is a diagram illustrating a system overview in an embodiment of the present invention;

FIG. 2 is an example of a block diagram of a storage device in the embodiment of the present invention;

FIG. 3 is an example of a QoS management table in the embodiment of the present invention;

FIG. 4 is an example of an API group management table in the embodiment of the present invention;

FIG. 5 is an example of an API group operation interval management table in the embodiment of the present invention;

FIG. 6 is an example of an API cache table in the embodiment of the present invention;

FIG. 7 is an example of a flowchart of API group management table update processing in the embodiment of the present invention;

FIG. 8 is an example of a flowchart of API group deletion processing from the API group management table in the embodiment of the present invention;

FIG. 9 is an example of a flowchart of API group operation interval management table update processing in the embodiment of the present invention;

FIG. 10 is an example of a flowchart of API execution prediction processing in the embodiment of the present invention;

FIG. 11 is an example of a flowchart of resource allocation processing in the embodiment of the present invention;

FIG. 12 is a diagram illustrating queue control processing in the embodiment of the present invention;

FIG. 13 is an example of a flowchart of execution API queue processing in the embodiment of the present invention; and

FIG. 14 is an example of a flowchart of resource allocation processing for a periodic request in the embodiment of the present invention.

### DESCRIPTION OF THE PREFERRED EMBODIMENTS

Hereinafter, embodiments of the present invention will be described with reference to the drawings. It should be noted that in the respective drawings illustrating the embodiments, the same components are denoted by the same names and reference numerals as much as possible, and repeated descriptions thereof will be omitted.

The present invention is not limited to the embodiments described below and includes various modifications and equivalent configurations within the spirit of the appended claims. For example, the above-described embodiments are described in detail for easy understanding of the present invention, and are not necessarily limited to those including all the configurations described.

In addition, the processing unit described in the embodiments may be implemented by hardware by designing some or all of them with, for example, an integrated circuit, or may be implemented by software by a processor interpreting and executing a program for implementing each function.

The table, the area, and the like described in the embodiments may be a database (DB) or data stored in a main storage memory.

### First Embodiment

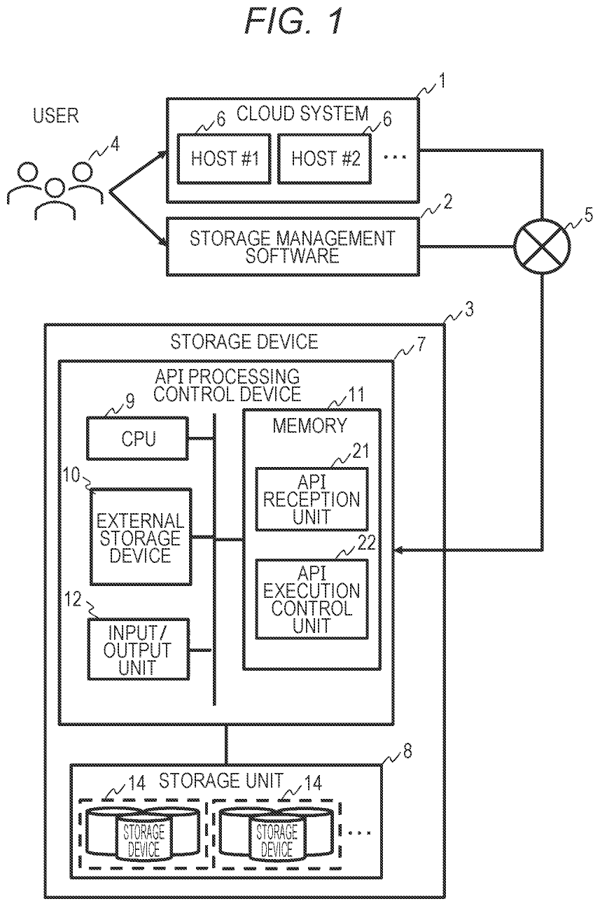

FIG. 1 is a diagram illustrating a system overview according to an embodiment of the present invention. A command is input from a user 4 to a cloud system 1 or storage management software 2. The cloud system 1 is provided with a plurality of hosts 6. A command input to the cloud system 1 or the storage management software 2 is converted into a plurality of application programming interfaces (APIs) and transmitted to the storage device 3 via the network 5. The API functions as a command or a program for operating the storage device.

The storage device includes an API processing control device 7 and a storage unit 8, and the API processing control device 7 includes a computer including a central processing unit (CPU) 9, a memory 11, an external storage device 10, an input/output unit 12, and the like. The storage unit 8 includes a plurality of storage devices 14 and is connected to the API processing control device 7, receives an API from the API processing control device 7, and executes processing instructed by the user 4.

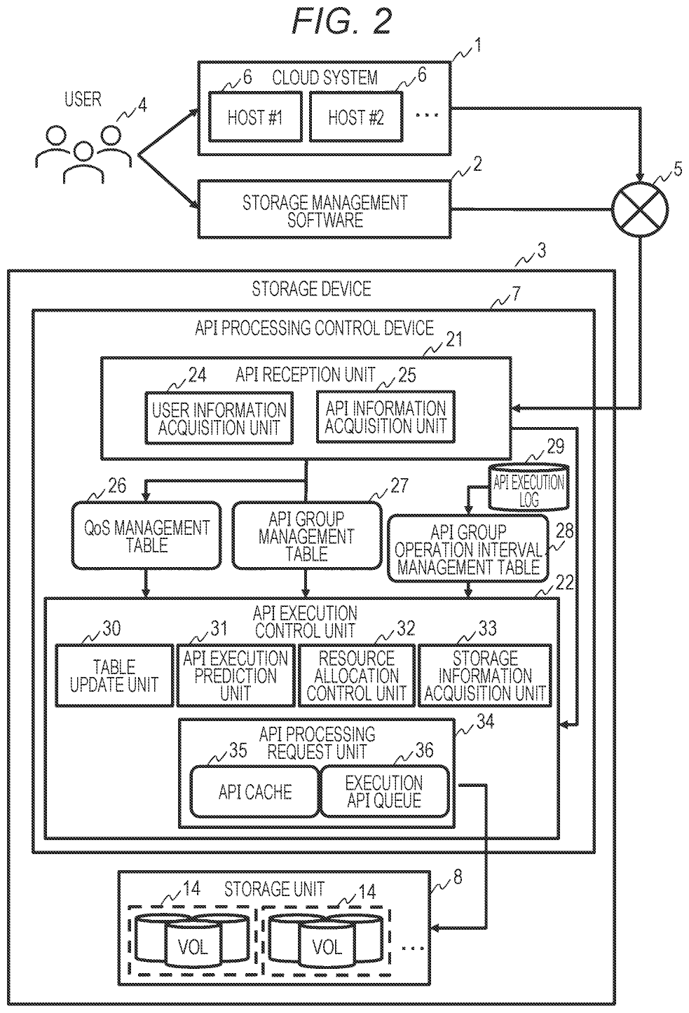

FIG. 2 illustrates a software module of the API processing control device 7 whose hardware configuration is illustrated in FIG. 1, and various tables stored in the external storage device 10 and accessed by the software module.

The API processing control device 7 includes an API reception unit 21 that receives an API from the cloud system 1 or storage management software and an API execution control unit 22 that controls execution of the API received by the API reception unit 21.

The API reception unit 21 includes a user information acquisition unit 24 that acquires information on a user who is an issuer having issued the API and an API information acquisition unit 25 that acquires the information itself on the API.

The API execution control unit 22 includes a table update unit 30 that updates various tables, an API execution prediction unit 31 that predicts execution of the API, a resource allocation control unit 32 that allocates a resource such as a CPU for executing the API, a storage information acquisition unit 33 that acquires storage information, and an API processing request unit 34 that requests the storage unit 8 to perform API processing.

The API processing request unit 34 includes an API cache 35 that stores an API group being executed and an execution API queue 36 having a queue of APIs to be executed as a core.

Furthermore, the external storage device 10 stores a QoS management table 26, an API group management table 27, an API execution log 29, and an API group operation interval management table 28.

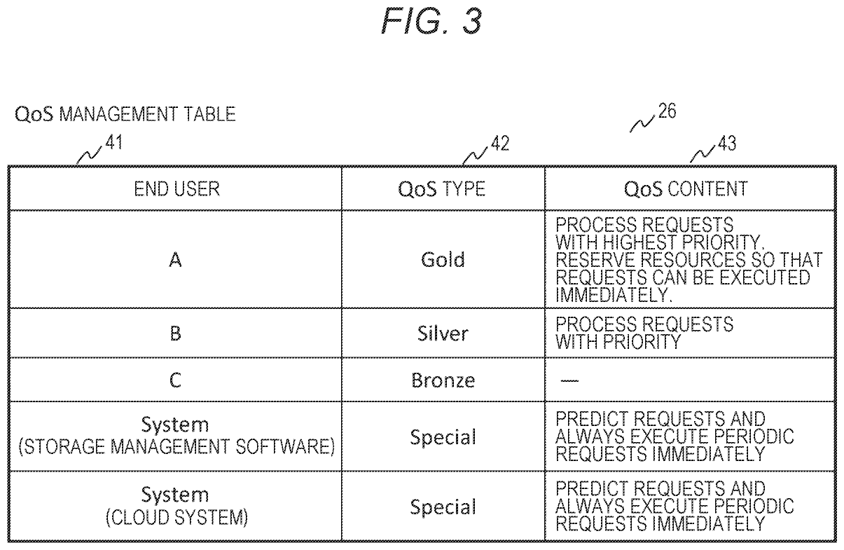

FIG. 3 is an example of a QoS management table in an embodiment of the present invention. The end user 41 executing the API, the QoS type 42 indicating the priority order of QoS, and the QoS content 43 indicating the priority content of each QoS type are stored in association with each other.

In this example, as the end user 41, users 4 of three types of A, B, and C and system end users of storage management software and a cloud system are defined. The QoS type 42 has three-stage user priority orders of Gold, Silver, and Bronze and a system priority order of Special. The priority order becomes higher in the order of Bronze, Silver, Gold, and Special.

In the QoS content, the QoS type Bronze indicates that the priority order is not controlled because of having the lowest priority order. In the QoS type Silver, control is performed to advance the execution order in the execution API queue 36 in order to preferentially process the request. In the QoS type Gold, in order to further increase the execution priority of the API, not only the execution API queue 36 is controlled but also resources necessary for the API execution are reserved. Since having the highest priority order, the QoS type Special controls the execution API queue 36 and reserves resources, so as to be capable of being immediately executed.

How much control of the execution API queue 36 and reserving of resources are performed in the QoS types Silver and Gold of the user depends on the system to be applied. Therefore, how much the API execution order is advanced in the control of the execution API queue 36, the type of the CPU reserved by resource reserving, the time reserved, and the like are changed.

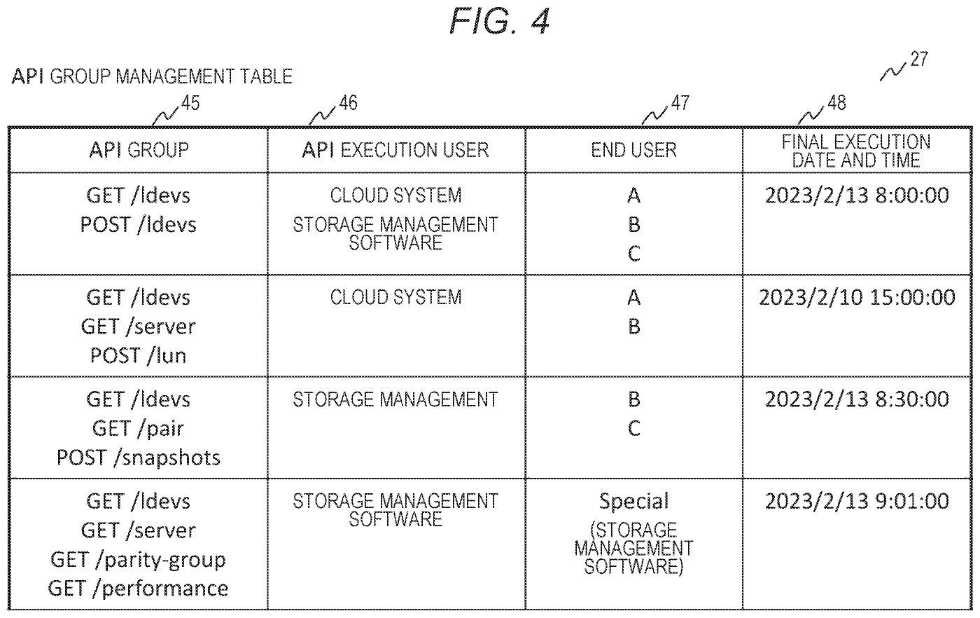

In addition, a QoS type whose priority order is lowered may be prepared, and may be executed when the load of the storage system is lowered. FIG. 4 is an example of an API group management table in an embodiment of the present invention. An API group 45 to be executed, an API execution user 46 who is an execution user of the API group, an end user 47, and a final execution date and time 48 are stored in association with each other.

GET/ldevs and POST/ldevs in the first line are an API group for newly creating a volume, and are executed from both the cloud system and the storage management software. There are records of execution from three end users A, B, and C, and the final execution date and time is 2023 Feb. 13 8:00:00.

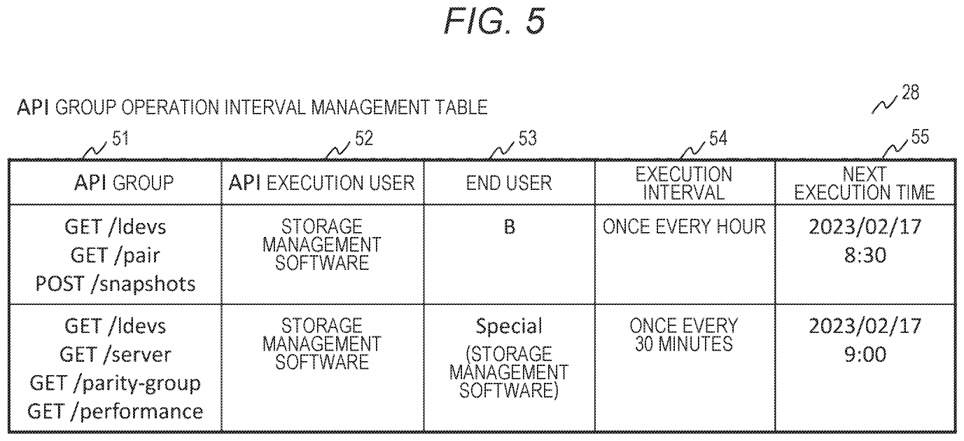

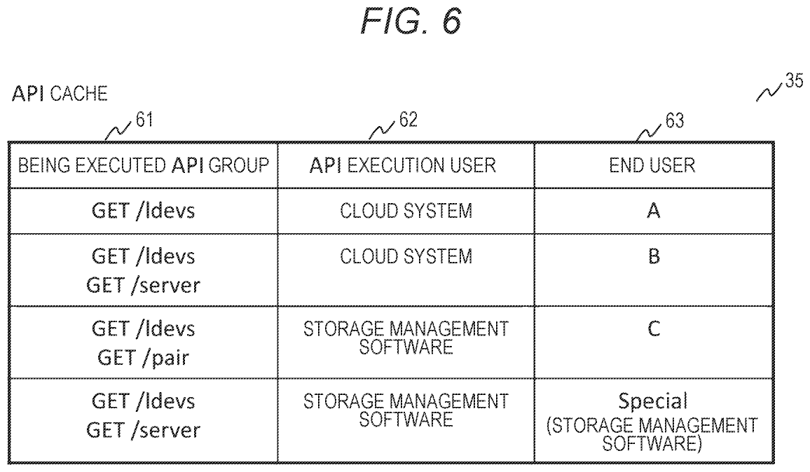

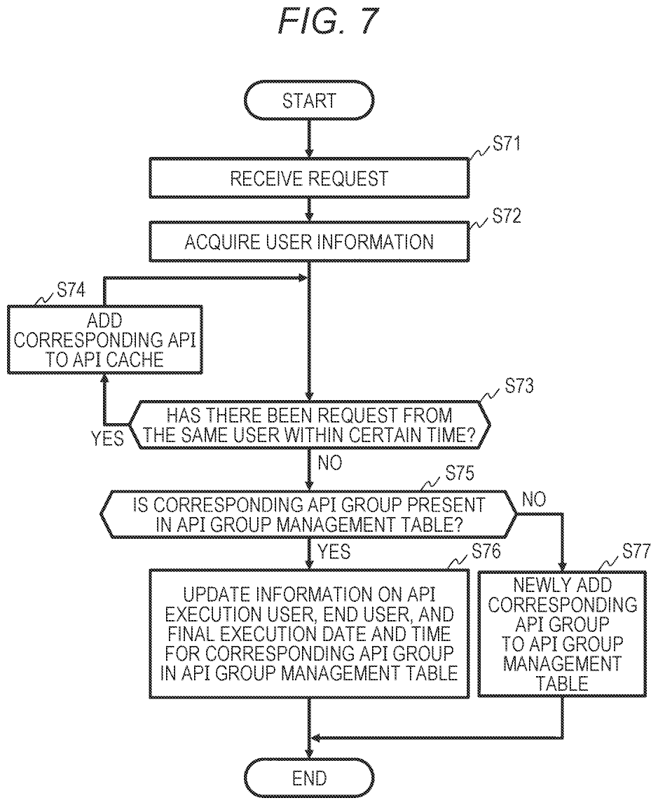

Similarly, the second line is mapping processing of connecting to a server and a volume, the third line is backup processing of acquiring a snapshot, and the fourth line is processing of acquiring performance information and configuration information. The end user does not need to be a person and may be a script or a tool. FIG. 5 is an example of an API group operation interval management table in an embodiment of the present invention. Information on the execution interval 54 and the next execution time 55 which is the next execution predicted time is added to the API group management table in FIG. 4. FIG. 6 is an example of an API cache table in an embodiment of the present invention. This table is a table that stores information on an API group that is being executed and an API group that has been executed recently. For example, information on an API group executed within the past one second is included, and information on an API group whose processing has been completed is also included. FIG. 7 is an example of a flowchart of API group management table update processing according to the embodiment of the present invention. The API reception unit 21 receives a request for API execution (S71). Next, the user information acquisition unit 24 acquires the user information such as the API execution user 46, the end user 47, and the like of the received request and stores the user information in the API group management table 27 (S72). If there is an API execution request from the same user within a certain time (S73), the API execution request is likely to be an execution request for an API group, and thus the API is registered in the API cache 35 (S74).

If there is no request from the same user within a certain period of time, that is, when it is determined that the API group execution request from the user has ended, it is determined whether the API group requested from the user is registered in the API group management table 27 (S75).

If the API group having received the execution request from the user is registered in the API group management table 27, the final execution date and time 48 of the API group management table 27 is updated (S76).

If the API group that has received the execution request from the user is not registered in the API group management table 27, an API group that has newly received the execution request is added to the API group management table 27 (S77).

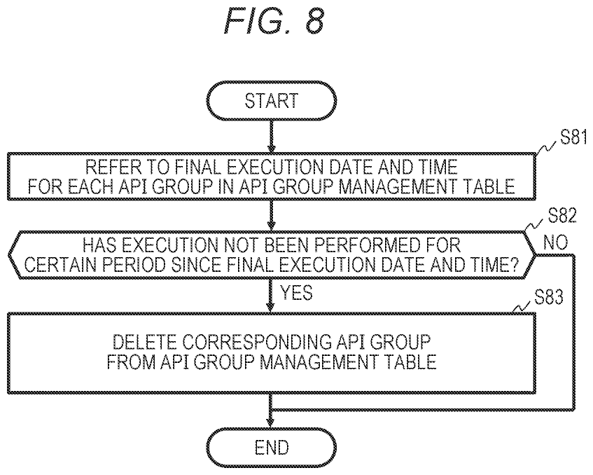

FIG. 8 is an example of a flowchart of API group deletion processing from the API group management table according to the embodiment of the present invention. The final execution date and time 48 of each API group registered in the API group management table is referred to (S81).

If the API group has not been executed for a certain period from the final execution date and time 48 (S82), the API group is deleted from the API group management table (S83). If it is executed, the API group is held.

Although this processing depends on the application of the storage system, if the API group deletion processing is performed about once a month, it is possible to avoid the API group management table becoming large and the processing performance of the storage system being lowered.

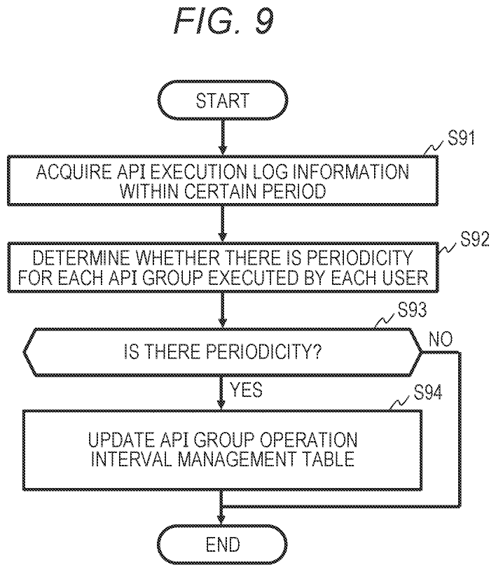

FIG. 9 is an example of a flowchart of API group operation interval management table update processing according to the embodiment of the present invention. API execution log information is acquired (S91), and it is determined whether there is periodicity for each API group executed by each user (S92). If it is determined that there is periodicity (S93), the API group is registered in the API group operation interval management table 28 together with the execution interval 54 and the next execution time 55. In addition, when the API group is already registered in the API group operation interval management table, it is checked whether there is a change in the registered execution interval 54, and if there is a change, the execution interval 54 and the next execution time 55 are updated. If it is determined that there is no periodicity, registration is not performed.

Although the API group operation interval management table update processing depends on the use of the storage system, if the API group operation interval management table update processing is performed about once a month, the API can be executed according to the latest storage operation method.

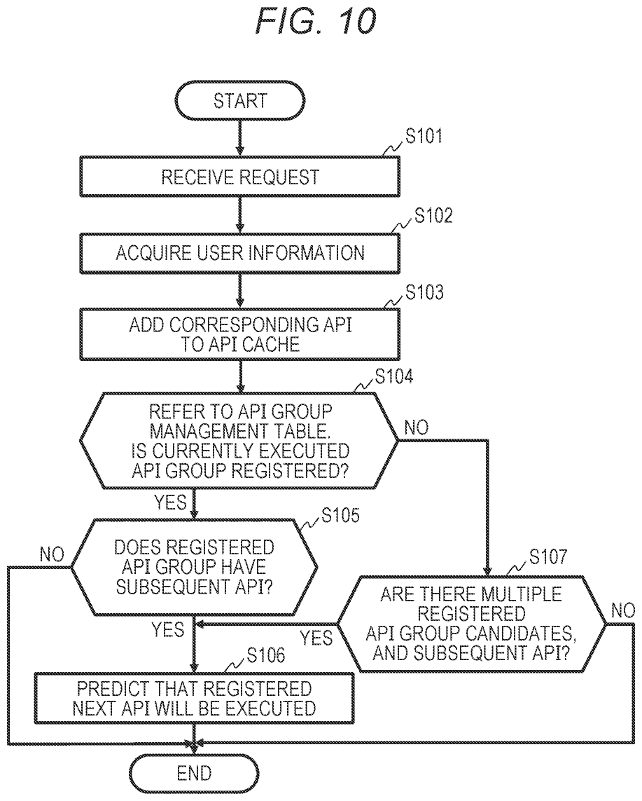

FIG. 10 is an example of a flowchart of API execution prediction processing according to the embodiment of the present invention. The API reception unit 21 receives an API execution request (S101), acquires user information (S102), and adds the user information to the API cache 35 (S103).

The API execution prediction unit 31 refers to the API group management table and determines whether the currently executed API group is registered (S104). In this determination, it is determined whether the arrangement of the APIs included in the API group completely matches. If it is determined that the currently executed API group is registered, it is determined whether the registered API group has a subsequent API (S105). If the registered API group has a subsequent API, it is predicted that the registered next API will be executed (S106).

If it is determined in S104 that the API group is not registered, it is determined whether there are a plurality of registered API group candidates and there is a subsequent API (S107). If there are a plurality of registered API group candidates and there is a subsequent API, the registered next API is predicted to be executed (S106).

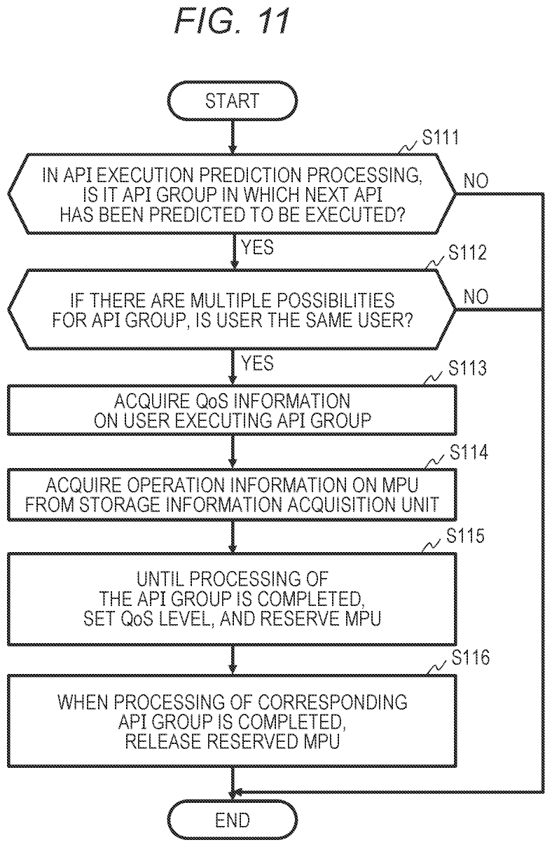

FIG. 11 is an example of a flowchart of resource allocation processing according to the embodiment of the present invention. In the API execution prediction processing, it is determined whether to be an API group in which the next API is predicted to be executed (S111). If the next API is not executed, the processing is ended.

If there are a plurality of possibilities for the API group in which the next API is executed in S111, it is determined whether the user is the same user (S112). If the user is not the same user, the processing is ended. If the user is the same user, QoS information on a user executing the API group is acquired (S113), and operation information on a microprocessor unit (MPU) is acquired from a storage information acquisition unit (S114).

Until the processing of the API group is completed, the QoS level based on the QoS type of the user is set, and the MPU is reserved. However, when an API group having a QoS level higher than that of the API group is issued, there is a possibility that the reserved processor is deprived. Not only the MPU but also the memory and the volume may be reserved.

Then, when the processing of the API group is completed, the reserved resources such as the MPU are released.

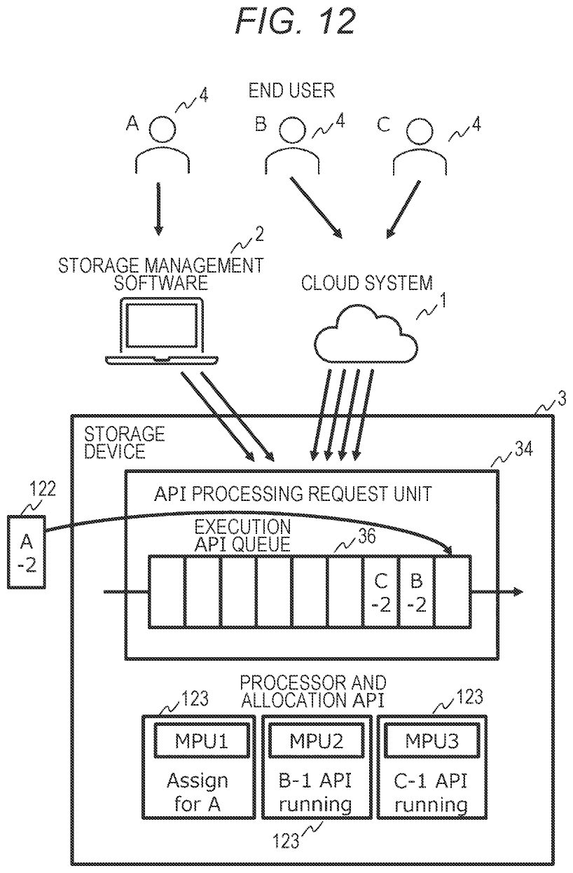

FIG. 12 is a diagram illustrating queue control processing according to the embodiment of the present invention. The API processing request unit 34 of the storage device 3 includes an execution API queue 36. The API that has received the execution request is registered in the execution API queue. In this example, APIs of B-2 and C-2 are registered, and B-1 and C-1 of APIs having been registered in the execution API queue 36 are executed by the MPU 2 and the MPU 3, respectively. The MPU 1 is reserved for executing the API of the user A whose QoS type is Gold.

In this state, when an execution request of A-2 which is an API from the end user A is received, the A-2 is registered to the head of the execution API queue. Then, an API is immediately executed in the MPU 1 reserved for Gold.

By performing such control, it is possible to execute an API with high priority. However, when a plurality of API execution requests from the end user A of Gold are received in the same time period, one MPU can be reserved for each end user, and thus there is a possibility that an MPU having been reserved for another newly received request is allocated.

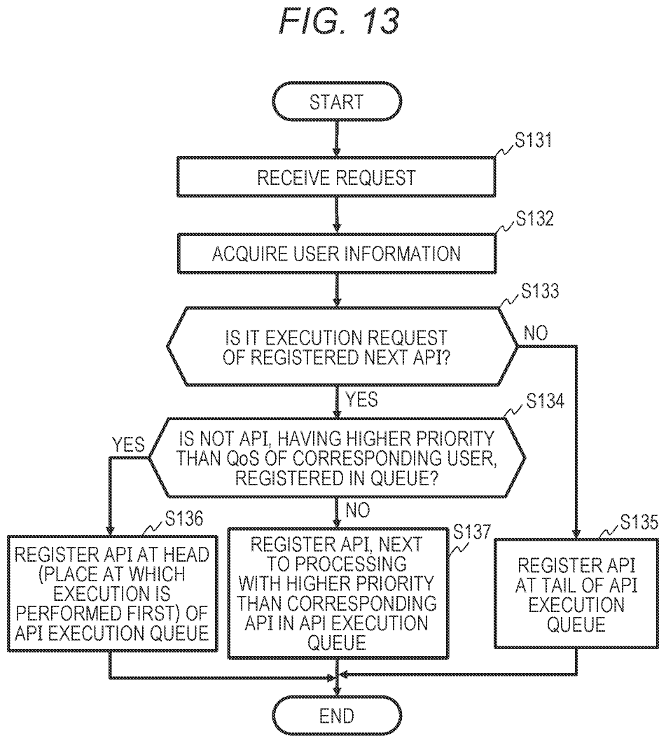

FIG. 13 is an example of a flowchart of execution API queue processing in the embodiment of the present invention. The API reception unit 21 receives the API execution request (S131), acquires the user information (S132), and determines whether to be the next API execution request registered in the API group management table 27 as the API group (S133). If the request is not the registered next API execution request, the API is registered at the tail of the execution API queue 36 (S135).

In the case of the registered next API (YES), it is determined whether an API having a higher priority than the QoS type of the user is registered in the queue (S134).

If an API with high priority is not registered in the queue (YES), the API is registered at the head, at which the API is executed first, of the execution API queue 36. If an API with a high priority is registered in the execution API queue 36 (NO), the API is registered next to the processing with a higher priority than the corresponding API in the execution API queue 36.

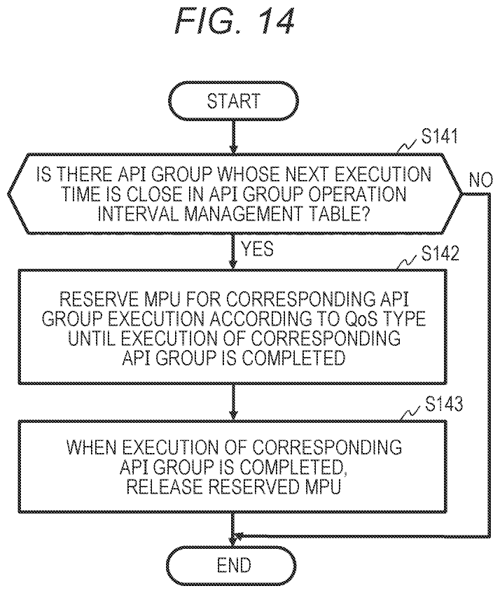

FIG. 14 is an example of a flowchart of resource allocation processing for a periodic request according to the embodiment of the present invention. It is determined whether there is an API group whose next execution time is close in the API group operation interval management table (S141). The determination of whether to be close to depends on the operation of the storage system, but a time of 1 second to several seconds is usually set.

If there is an API group whose next execution time is close, the MPU 123 is reserved for the API group execution, according to the QoS type until the execution of the API group is completed (S142). When the execution of the API group is completed, the reserved MPU 123 is released (S143).

In this example, the reservation for the MPU has been described as an example, but the reservation for the memory or the disk volume is also controlled as necessary.

What is claimed is:

1. An API execution control system comprising:
an API reception unit configured to receive a plurality of successive API execution requests from a user;
a table update unit configured to detect patterns of the plurality of received successive API execution request and register the detected patterns of the plurality of successive API execution requests in an API group management table;
an API execution prediction unit configured to determine whether the API execution request received by an API reception unit matches the pattern registered in the API group management table; and
an API execution control unit configured to, when it is determined that the API execution request received by an API execution prediction unit matches the pattern registered in the API group management table, raise an execution priority of an API whose next execution request is to be received.

2. The API execution control system according to claim 1, further comprising a QoS management table in which a user and a priority order of the user are registered in association with each other,
wherein the API execution control unit refers to the QoS management table and changes a priority improvement method for raising an execution priority of an API whose execution request is received based on the priority order of the user of an API execution request source.

3. The API execution control system according to claim 2, wherein the priority improvement method reserves a processing device for executing the API whose execution priority is to be raised.

4. The API execution control system according to claim 2, further comprising a queue in which an execution order of an API is registered,
wherein the priority improvement method advances an execution order in a queue of the API whose execution priority is to be raised.

5. The API execution control system according to claim 2, wherein
the table update unit detects a pattern of an API whose execution request is periodically received from a user, and registers the detected pattern of the API in the API group management table, and
the API execution control unit, at a predetermined time of a next execution scheduled time, which is registered in the API group management table, of an API whose execution request is periodically received, executes a priority improvement method based on a priority associated with a user of the API.

6. The API execution control system according to claim 2, wherein the table update unit deletes a pattern that has not been executed within a predetermined time among patterns registered in the API group management table.

7. The API execution control system according to claim 2, wherein
the API group management table includes information indicating a final execution date and time for each registered pattern, and
when a pattern registered in the API group management table is executed, the table update unit updates a final execution date and time corresponding to the executed pattern.

8. An API execution control method comprising:
by an API reception unit, receiving a plurality of successive API execution requests from a user;
by a table update unit, detecting patterns of the plurality of received successive API execution requests and register the detected patterns of the plurality of successive API execution requests in an API group management table;
by an API execution prediction unit, determining whether the API execution request received by the API reception unit matches the pattern registered in the API group management table; and
by an API execution control unit, when it is determined that the API execution request received by the API execution prediction unit matches the pattern registered in the API group management table, raising an execution priority of an API whose next execution request is to be received.

9. The API execution control method according to claim 8, further comprising providing a QoS management table in which a user and a priority order of the user are registered in association with each other,
wherein the API execution control unit refers to the QoS management table and changes a priority improvement method for raising an execution priority of an API whose execution request is received based on the priority order of the user of an API execution request source.

10. A program causing a computer to execute procedures of:
receiving a plurality of successive API execution requests from a user;
detecting patterns of the plurality of received successive API execution requests and registering the detected patterns of the plurality of successive API execution requests in an API group management table;
determining whether the API execution request received by an API reception unit matches the pattern registered in the API group management table; and
when it is determined that the API execution request received by an API execution prediction unit matches the pattern registered in the API group management table, raising an execution priority of an API whose next execution request is to be received.
